(19) United States
(12) Patent Application Publication
(10) Pub. No.: US 2004/0106317 A1
(43) Pub. Date: Jun. 3, 2004

(54) EDGE CARD CONNECTOR AND AN ASSEMBLY OF THE EDGE CARD CONNECTOR WITH AN INSERTED CARD

(76) Inventor: James R. Koser, Elizabethtown, PA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/309,456

(22) Filed: Dec. 3, 2002

(51) Int. Cl. H01R 13/62

(52) U.S. Cl. 439/325

(57) ABSTRACT

An electrical connector assembly includes an electrical connector (1) and a card (5) having a wedge (52) to be inserted into the connector. The connector includes a dielectric housing (2) having a head section (20) in which a number of contacts (3) retained therein and a bottom plate (22) extending rearwardly from a lower portion of the head section. The head section defines a receiving slot (200) to divide the head section into an upper wall (25) and a lower wall (26). The contacts include engaging portions (30) extending downwardly into the receiving slot for electrically contacting with the card. The lower wall of the head section defines an inclined plane (260) to cooperate with the wedge to maintain the card constantly parallel to the bottom plate of the housing during the insertion of the card.

### BACKGROUND OF THE INVENTION

1. Field of the Invention

The present invention relates to an edge card connector and an assembly of the edge card connector with an inserted card, and particularly to a low insertion force (LIF) edge card connector and an assembly of the LIF edge card connector with an inserted card.

2. Description of Related Art

Edge card connectors, such as PCMCIA (Personal Computer Memory Card International Association) card connectors, are widely used in electronic products for electrically connecting with inserted electronic cards which function as removable mass storage devices. A typical edge card connector comprises a dielectric housing defining a receiving slot therein and a plurality of contacts retained in the housing. The contacts have mating portions extending into the receiving slot for engaging with golden fingers of an inserted electronic card.

U.S. Pat. No. 5,380,997 discloses a smart card reader comprising a base part and a plate which together form a compartment and a plurality of contacts having free ends located above an upper surface of the base part. When a smart card is inserted into the compartment of the smart card reader, the free ends of the contacts resiliently abut against circuit traces of the smart card to thereby establishing an electrical connection therebetween.

However, the contacts of these conventional edge card connectors are easy to wear out due to initial wipe of a front edge of the card when the card repeatedly inserts into the edge card connector, whereby an electrical connection is adversely affected between the edge card connector and the inserted card. At the same time, the use life of the edge card connector is accordingly decreased, thereby increasing the manufacturing cost.

In order to meet the requirement of high durability, the edge card connectors and the inserted electronic cards are then developed to have a pin and socket engagement but the manufacturing cost of pin and socket contacts is too high.

Hence, an improved edge card connector is required to overcome the disadvantages of the related art.

### SUMMARY OF THE INVENTION

Accordingly, a first object of the present invention is to provide an edge card connector which can reduce initial wipe of the mating portions of the contacts thereof during the insertion of a card, thereby ensuring high durability of the edge card connector.

A second object of the present invention is to provide an assembly of the edge card connector with an inserted card, the assembly being so configured that initial wipe of the contacts of the edge card connector can be reduced and the card can be constantly maintained in a horizontal plane.

In order to achieve the objects set forth, an edge card connector in accordance with the present invention comprises a dielectric housing including a head section in which a plurality of contacts retained therein and a bottom plate extending rearwardly from a lower portion of the head section. The head section defines a receiving slot to divide the head section into an upper wall and a lower wall. The contacts have engaging portions extending downwardly into the receiving slot for electrically contacting with a mating edge of an inserted card. The lower wall of the head section defines an inclined plane opposite to the engaging portions of the contacts. The inserted card has a wedge formed on a rear bottom surface thereof. The inclined plane of the connector and the wedge of the card simultaneously raise the card to present gold pads or gold blade contacts of the card into contact with the contacts. This prevents a front edge of the card from scraping the contacts to thereby avoiding initial wipe therebetween.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an edge card connector in accordance with the present invention and a pair of small-dimensioned cards inserted thereinto;

FIG. 2 is a bottom perspective view of the card shown in FIG. 1;

FIG. 3 is a perspective view showing the edge card connector receiving a large-dimensioned card therein;

FIG. 4 is a top perspective view of the card shown in FIG. 3;

FIG. 5 is a bottom perspective view of the card shown in FIG. 3; and

FIGS. 6A to 6E are cross-sectional views showing the relative positions of the card in relation to the edge card connector during the insertion of the card.

### DETAILED DESCRIPTION OF THE INVENTION

Reference will now be made in detail to the preferred embodiment of the present invention.

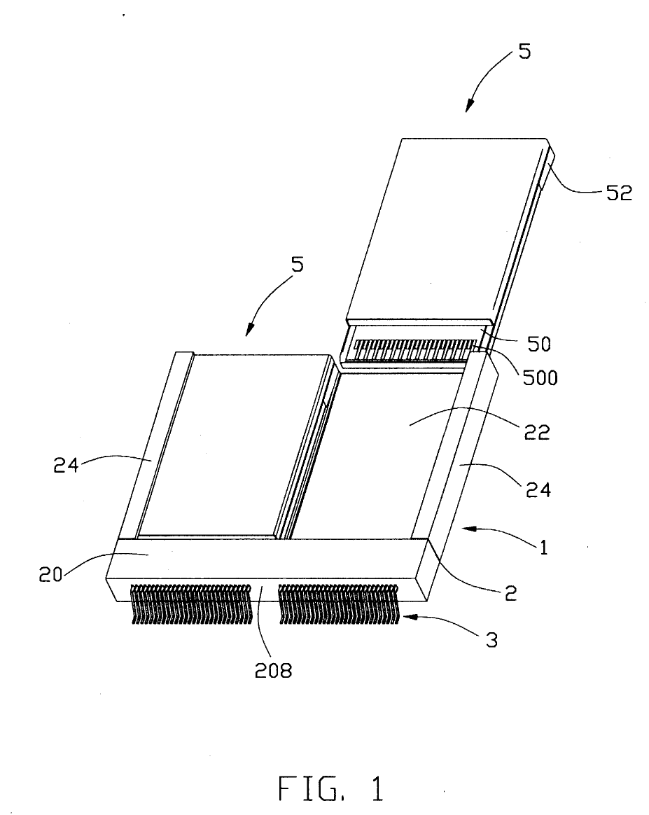

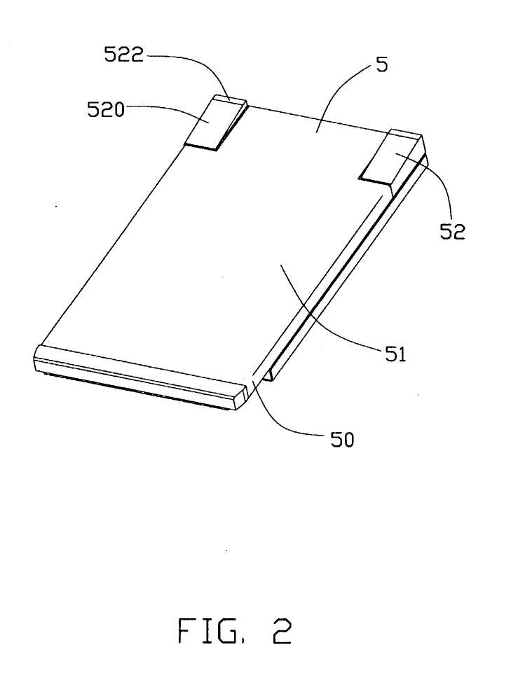

Referring to FIGS. 1 and 2, an edge card connector 1 in accordance with the present invention and a pair of small-dimensioned cards 5 to be inserted into the edge card connector 1 in a side-by-side manner are shown. Each card 5, which is generally of a step-shaped configuration, includes a lower front mating portion 50 and a pair of wedges 52 formed on a rear, bottom surface 51 thereof. Each wedge 52 has a ramp 520 and a horizontal plane 522 parallel to the bottom surface 51. The mating portion 50 has a plurality of gold pads or gold blade contacts 500 on an upper surface thereof.

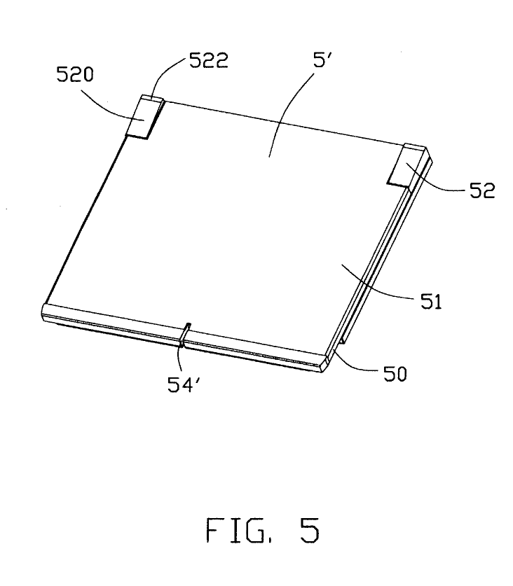

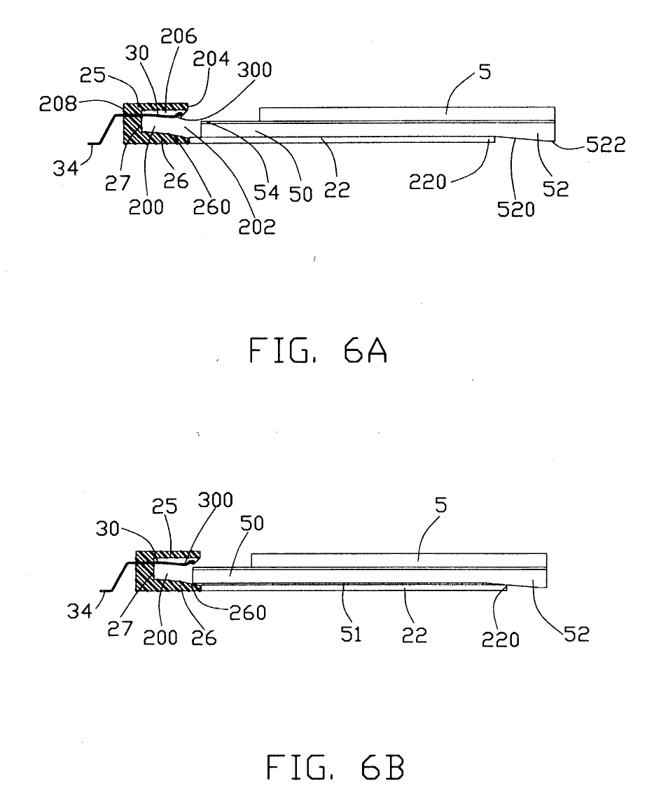

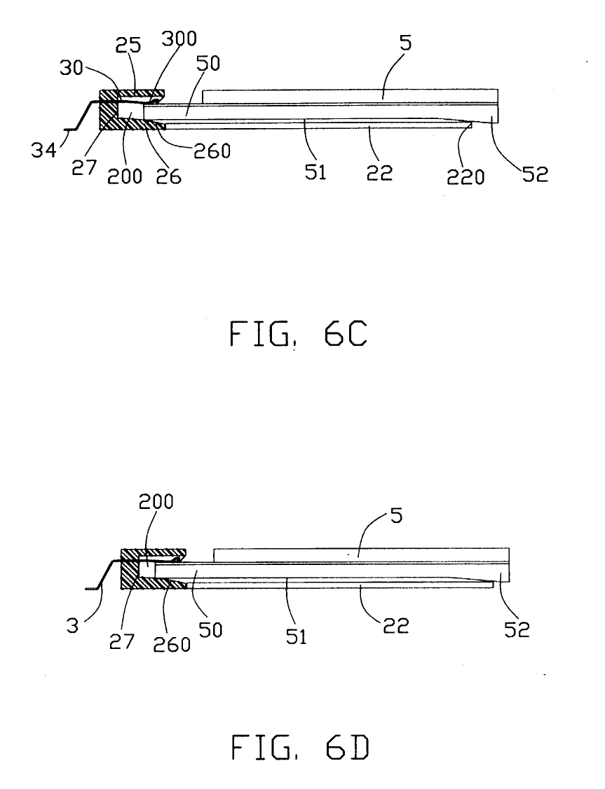

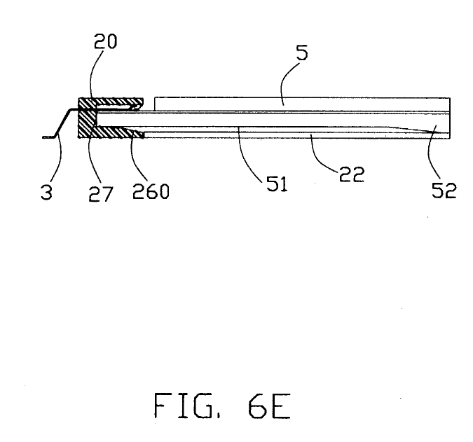

Referring to FIG. 6A in conjunction with FIG. 1, the edge card connector 1 comprises a dielectric housing 2 including an elongated head section 20 in which a plurality of contacts 3 are provided for electrical connection with the card 5, a bottom plate 22 extending rearwardly from a lower portion of the head section 20 and a pair of guiding arms 24 projecting upwardly from opposite side edges of the bottom plate 22 for guiding the insertion of the cards 5. The head section 20 defines a receiving slot 200 with an opening 202 in a rear face 204 for the entrance of the card 5. The head section 20 is divided into an upper wall 25 and a lower wall 26 by the receiving slot 200. The upper wall 25 defines a plurality of passageways 206 communicating with the receiving slot 200 and penetrating through a front face 208 of the head section 20. The lower wall 26 defines an inclined plane 260 which gradually ascends from the opening 202. The head section 20 also has a vertical surface 27 substantially parallel to the front face 208 for functioning as a stop for the card 5 (see FIG. 6E).

Each contact 3 includes an engaging portion 30 received in a corresponding passageway 206 of the head section 20 for electrically contacting with the gold pads or gold blade contacts 500 of the card 5, and a solder portion 34 forwardly extending out of the front face 208 of the head section 20 for electrically connecting to a printed circuit board (not shown) on which the edge card connector 1 is mounted. The engaging portion 30 of each contact 3 has an engaging point 300 extending downwardly into the receiving slot 200. The engaging point 300 is positioned between highest and lowest ends of the inclined plane 260.

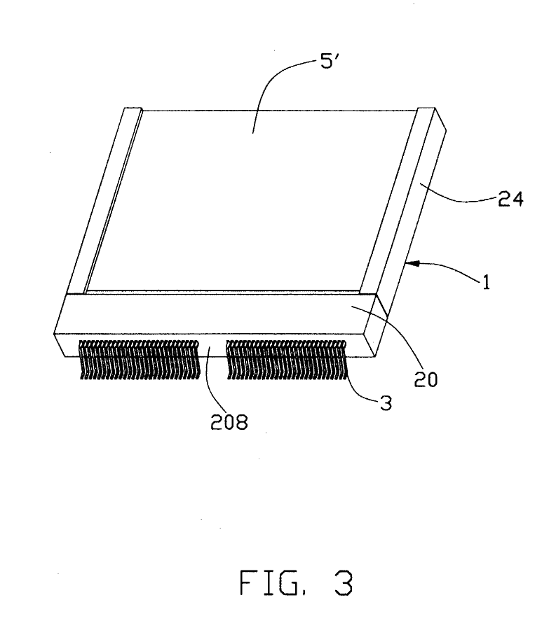

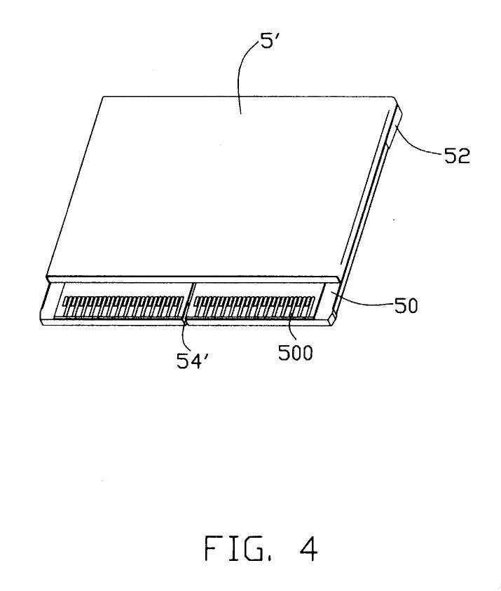

FIGS. 3-5 show the edge card connector 1 with a large-dimensioned card 5′ received therein. The large-dimensioned card 5′ is substantially equal to the pair of small-dimensioned cards 5 arranged side by side with a keyway 54′ defined at the mating portion 50 thereof for engaging with a key (not shown) positioned in the receiving slot 200 of the head section 20.

FIGS. 6A-6E show the relative positions of the card 5 in relation to the edge card connector 1 during the insertion of the card 5. As is seen in FIG. 6A, the card 5 is inserted into a point at which a rear edge 220 of the bottom plate 22 just touches a start of the ramp 520. The card 5 can be upwardly guided by the ramp 520 during an engagement between the ramp 520 and the rear edge 220. In this state, the bottom surface 51 of the card 5 is still applied against the bottom plate 22 of the housing 2.

In the following stage, illustrated in FIG. 6B, a front edge 54 of the card 5 is engaged on the inclined plane 260 and the rear edge 220 of the bottom plate 22 is engaged on the ramp 520. It is noted that the inclined plane 260 and the ramp 520 cooperate with each other to maintain the card 5 constantly parallel to the bottom plate 22.

In the stage illustrated in FIG. 6C, the front edge 54 of the card 5 just reaches the highest end of the inclined plane 260 and the gold pads or gold blade contacts 500 of the card 5 comes into contact with the engaging points 300 of the contacts 3. It is noted that the inclined plane 260 of the edge card connector 1 and the ramp 520 of the card 5 simultaneously raise the card 5 to present the gold pads or gold blade contacts 500 of the card 5 into contact with the contacts 3. This prevents the front edge 54 of the card 5 from scraping the contacts 3 to thereby avoiding initial wipe therebetween.

In the stage illustrated in FIG. 6D, the card 5 further moves forwardly until the card 5 abuts against the stop 27 of the connector 1 and that the horizontal plane 522 of the wedge 52 abuts against the bottom plate 22 of the housing 2, as is clearly shown in FIG. 6E, whereby the card 5 is fully inserted into the edge card connector 1.

Obviously, during the withdrawal of the card 5 out of the receiving slot 200, the same positions as have been described are reached in reverse order.

It can be understood that during the insertion/withdrawal of the large-dimensioned card 5′ into/from the edge card connector 1, the card 5′ has the same relationship with the edge card connector 1 as that have been described before. It also can be understood that the card 5 may defines only one wedge on the bottom surface 51 to achieve the same result as the pair of wedges 52.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for being mounted on a printed circuit board, comprising:
a dielectric housing having a head section and a bottom plate extending rearwardly from a lower portion of the head section, the head section defining a receiving slot to divide the head section into an upper wall and a lower wall; and
a plurality of contacts retained in the head section each including an engaging portion extending downwardly into the receiving slot and a solder portion extending out of the head section for electrically connecting to the printed circuit board;
wherein the lower wall of the head section defines an inclined plane opposite to the engaging portions of the contacts, the engaging portions having engaging points positioned between highest and lowest ends of the inclined plane along the insertion direction of a card into the receiving slot.

2. The electrical connector as claimed in claim 1, wherein the housing has a pair of guiding arms projecting upwardly from opposite side edges of the bottom plate for guiding the insertion of the card.

3. An electrical connector assembly comprising:
a card having a wedge formed on a rear bottom surface thereof; and
an electrical connector comprising:
a dielectric housing having a head section and a bottom plate extending rearwardly from a lower portion of the head section, the head section defining a receiving slot to divide the head section into an upper wall and a lower wall; and
a plurality of contacts retained in the head section with engaging portions extending downwardly into the receiving slot for electrically contacting with the card;
wherein the lower wall of the head section defines an inclined plane along the insertion direction of the card into the receiving slot and opposite to the engaging portions of the contacts, the inclined plane cooperating with the wedge to maintain the card constantly parallel to the bottom plate of the housing during the insertion of the card into the connector.

4. The electrical connector assembly as claimed in claim 3, wherein the wedge has a ramp and a horizontal plane parallel to the bottom plate, and a rear edge of the bottom plate is engaged on the ramp during the insertion of the card.

5. The electrical connector assembly as claimed in claim 4, wherein the housing has a pair of guiding arms projecting upwardly from opposite side edges of the bottom plate to guide the insertion of the card.

6. An electrical connector assembly comprising:
an edge card connector comprising:
a dielectric housing having a head section, a bottom plate extending rearwardly from a lower portion of the head section and a pair of guiding arms upwardly projecting from opposite side edges of the bottom plate;
a plurality of contacts retained in the head section; and
a pair of cards disposed on the bottom plate and arranged in a side-by-side manner between the guiding arms, the cards having mating portions electrically contacting with the contacts.

7. The electrical connector assembly as claimed in claim 6, wherein the head section of the housing defines a receiving slot to divide the head section into an upper wall and a lower wall, the contacts having engaging portions extending downwardly into the receiving slot.

8. The electrical connector assembly as claimed in claim 7, wherein the mating portions of the cards are received within the receiving slot of the head section to electrically contact with the engaging portions of the contacts.

9. The electrical connector assembly as claimed in claim 8, wherein the lower wall of the head section defines an inclined plane along the insertion direction of the card into the receiving slot and opposite to the engaging portions of the contacts.

10. The electrical connector assembly as claimed in claim 9, wherein each card has a wedge formed on a bottom surface thereof at a rear end away from the mating portion thereof to cooperate with the inclined plane for maintaining the card constantly parallel to the bottom plate of the housing during the insertion of the card.

11. An electrical connector assembly comprising:
an insulative housing having on a front portion a head section defining a receiving slot extending in a first direction along a longitudinal dimension of the housing and exposed to an exterior in a second direction perpendicular to said first direction;
one row of contacts located by one side of said receiving slot;
a bottom plate extending from the head section in said second direction;
an electronic card defining a narrowed front region adapted to be received in said receiving slot, a plurality of conductive pads located on said front region for mechanical and electrical engagement with the corresponding contacts, respectively; and
tapered mechanism formed on a rear portion of at least one of said housing and said electronic card to have the electronic card move relative to the housing in a third direction toward the contacts when the card is inserted into the receiving slot along said second direction;
said first direction, said second direction and said third direction being perpendicular to one another; wherein
most portions of the card are exposed outside the head section and supported by the bottom plate.
